(19) United States
(12) Patent Application Publication
(10) Pub. No.: US 2025/0118478 A1
(43) Pub. Date: Apr. 10, 2025

(54) THIN COUPLING INDUCTOR, MANUFACTURING METHOD, AND POWER SUPPLY MODULE

(71) Applicant: SHANGHAI METAPWR ELECTRONICS CO., LTD, Shanghai (CN)

(72) Inventors: Mingzhun ZHANG, Shanghai (CN); Qingdong CHEN, Shanghai (CN); Yahong Xiong, Shanghai (CN)

(73) Assignee: SHANGHAI METAPWR ELECTRONICS CO., LTD, Shanghai (CN)

(21) Appl. No.: 18/908,822

(22) Filed: Oct. 8, 2024

(30) Foreign Application Priority Data
Oct. 8, 2023 (CN) 202311293299.X

(51) Int. Cl. H01F 27/245; H01F 3/14; H01F 27/02; H01F 27/255; H01F 27/28; H01F 27/32; H01F 37/00; H01F 41/02; H01F 41/26

(52) U.S. Cl. CPC H01F 27/245; H01F 3/14; H01F 27/022; H01F 27/255; H01F 27/2804; H01F 27/324; H01F 37/00; H01F 41/0206; H01F 41/26

(57) ABSTRACT

A thin coupling inductor, a manufacturing method thereof and a power supply module are provided. The thin coupling inductor comprises a first assembly, a first magnetic core and a second magnetic core; the first assembly comprises a first winding main body, a second winding main body and a third magnetic core combination; and the first magnetic core and the second magnetic core have a thin-layer composite structure. The manufacturing method comprises the steps that a third magnetic core combination and a winding main body are arranged in the frame, and the PP material is pressed to form a stack body. The power supply module comprises a thin coupling inductor, a first switching element, a second switching element, an input capacitor and an output capacitor. The control signals of the first switching element and the second switching element are 180 degrees out of phase.

### CROSS-REFERENCE TO RELATED APPLICATION

This application claims the priority benefit of China application no. 202311293299.X, filed on Oct. 8, 2023. The entirety of the above-mentioned patent application is hereby incorporated by reference herein and made a part of this specification.

### BACKGROUND

In recent years, with the development of technologies such as data centers, artificial intelligence, supercomputers and the like, more and more ASIC with powerful functions are applied, such as a CPU, a GPU, a machine learning accelerator chip, a network switch chip and the like; a large amount of current is consumed, for example, the required current can reach thousands of amperes; and the current has the characteristic of rapid jump. A voltage regulator module consisting of buck circuits (Buck) is traditionally used to supply power to such loads. The voltage regulation module is also a Voltage Regulator Module (VRM), that is, the power supply module involved in the application. Meanwhile, in order to meet the requirements of load peak current, conversion efficiency and load dynamic, the VRM needs to have the characteristics of high steady-state inductance and low dynamic inductance and high saturation current capability. However, although the saturation flux density of the commonly used magnetic powder core material is high, the equivalent relative permeability is low (usually lower than 60); the ferrite material with high equivalent relative permeability is low in saturation flux density (usually lower than 0. 5 T); and the characteristics of high steady-state inductance, low dynamic inductance and high saturation current cannot be met. Due to the fact that the requirement for the thickness of the voltage regulator module is thinner and thinner, a thin type is urgently needed, and the inductor with high steady-state inductance, low dynamic inductance and high saturation current characteristic is needed.

According to the application, the nanocrystalline strip material is used as a magnetic material to realize the inductor in the VRM, and the thickness of the nanocrystalline strip material is less than 30 um; a sheet strip-shaped magnetic material with a width of less than 100 mm; the nanocrystalline strip is compatible with the advantages of a ferrite material and a magnetic powder core material, has high equivalent relative permeability (greater than 300), has high saturation magnetic flux density (up to 1.2 T), and has relatively low magnetic core loss density; therefore, the characteristic of the strip-shaped nanocrystalline magnetic material is very suitable for the inductor of the step-down circuit; and when the inductor in the multi-phase step-down circuit is a coupled inductor, the performance of the nanocrystalline strip has more obvious advantages.

### SUMMARY

In view of the above, one of the objectives of the present application is to provide a thin coupling inductor and a power supply module thereof. Based on a coupling inductor structure of a nanocrystalline strip material, a coupling inductor of a thin type, a high saturation current, a high steady-state inductance and a low dynamic inductance is obtained, so as to improve the power density, the steady-state performance and the dynamic performance of the power supply module.

A thin coupling inductor is characterized by comprising a first assembly, a first magnetic core and a second magnetic core;

The first magnetic core, the first assembly and the second magnetic core are stacked; the first assembly is arranged between the first magnetic core and the second magnetic core;

The first assembly comprises a first winding main body, a second winding main body and a third magnetic core combination; the third magnetic core combination, the first winding main body and the second winding main body are arranged in the same layer; the first winding main body and the second winding main body are arranged in parallel; at least one part of the third magnetic core combination is arranged on the outer sides of the first winding main body and the second winding main body;

Winding ends are arranged at the two ends of the first winding main body and the two ends of the second winding main body, and the winding end parts are arranged in the stacking direction;

The first magnetic core and the second magnetic core have a thin-layer composite structure; and the thin-layer composite structure comprises a plurality of magnetic material thin layers and an insulating layer arranged between the magnetic material thin layers.

Preferably, wherein the thin coupling inductor is provided with a first surface, a second surface, a first side surface, a second side surface, a third side surface and a fourth side surface; the first surface is opposite to the second surface, the first side surface is opposite to the third side surface, and the second side surface is opposite to the fourth side surface;

The thin coupling inductor further comprises a first copper layer, a second copper layer, an insulating layer, a power connector and a signal connector;

The first copper layer, the first magnetic core, the first assembly, the second magnetic core and the second copper layer are sequentially stacked from top to bottom; the insulating layer is arranged between the first copper layer and the first magnetic core, between the first magnetic core and the first assembly, between the first assembly and the second magnetic core, and between the second magnetic core and the second copper layer;

The power connector is electrically connected to the first copper layer and the second copper layer, and the power connector is disposed adjacent to the second side surface and the fourth side surface; the signal connector is electrically connected to the first copper layer and the second copper layer, and the signal connector is disposed adjacent to the first side surface and the third side surface.

Preferably, wherein the winding end part comprises a first end of the first winding, a second end of the first winding, a first end of the second winding and a second end of the second winding; the first end of the first winding and the second end of the first winding are connected with the first winding main body, and the first end of the second winding and the second end of the second winding are connected with the second winding main body; the first end of the first winding and the first end of the second winding respectively extend from the corresponding winding main body to the first copper layer and are electrically connected with the first copper layer; and the second end of the first winding and the second end of the second winding extend from the corresponding winding main body to the second copper layer and are electrically connected with the second copper layer.

Preferably, the first magnetic core and the second magnetic core are provided with slotted holes respectively, and the winding ends are arranged in the slotted holes.

Preferably, the winding end part is an electroplated metal part, or the winding end part is a welded metal part, or the winding end part and the corresponding winding main body are integrally formed.

Preferably, wherein the third magnetic core combination is made of a magnetic powder core material.

Preferably, wherein the third magnetic core combination comprises a third magnetic core, a fourth magnetic core and a fifth magnetic core;

The third magnetic core, the first winding main body, the fifth magnetic core, the second winding main body and the fourth magnetic core are sequentially arranged.

Preferably, wherein an air gap with a total height gap 1 (i.e., a first gap) is arranged between the third magnetic core and the first magnetic core and between the third magnetic core and the second magnetic core; and the total heights of the fourth magnetic core and the first magnetic core and between the fourth magnetic core and the second magnetic core is a gap1; and an air gap with a total height gap 2 (i.e., a second gap) is arranged between the fifth magnetic core and the first magnetic core and between the fifth magnetic core and the second magnetic core.

Preferably, wherein the total height gap1 is lower than or equal to the total height gap2.

Preferably, the total height gap1 is the sum of the heights of the assembly air gaps.

Preferably, the first assembly further comprises a first auxiliary winding main body and a second auxiliary winding main body; the first auxiliary winding main body and the first winding main body are arranged in parallel and are coupled; the second auxiliary winding main body and the second winding main body are arranged in parallel and are coupled; auxiliary winding ends are arranged at the two ends of the first auxiliary winding main body and the two ends of the second auxiliary winding main body; and the end parts of the auxiliary winding are arranged in the stacking direction.

Preferably, the thin coupling inductor is characterized in that the first magnetic core and the second magnetic core are respectively provided with a slot hole; the winding end part is arranged in the slot hole; and the end part of the auxiliary winding is arranged in the slot hole of the second magnetic core.

Preferably, the first assembly further comprises a PP material area and an outer frame; the first winding main body, the second winding main body and the third magnetic core are combined and arranged in the outer frame, and the PP material area is filled in a gap between the third magnetic core combination and the winding main body.

Preferably, wherein the magnetic material thin layer comprises at least one of a nanocrystalline magnetic material, an amorphous strip magnetic material, or a magnetic metal thin film.

Preferably, the insulating layer is a PP layer; and the first copper layer, the first magnetic core, the first assembly, the second magnetic core, the second copper layer and the insulating layer are laminated to form a stack body.

Preferably, the thin coupling inductor further comprises a plastic package body, wherein the plastic package body wraps the outer surface of the stack body, and the power connector and the signal connector are arranged along the surface of the plastic package body; and the winding end part is exposed out of the surface of the plastic package body.

Preferably, a through hole penetrating from the first surface to the second surface is formed in the stack body, and the power connector and the signal connector are arranged in the through hole.

Preferably, the thicknesses of the first winding main body, the second winding main body and the third magnetic core combination are same, the third magnetic core combination is a communication area, the third magnetic core combination is made of a magnetic powder core material, the third magnetic core combination surrounds at least three side edges of the first winding main body, and the third magnetic core combination surrounds at least three side edges of the second winding main body; and the first winding main body, the second winding main body and the third magnetic core combination form a first assembly by pressing.

A manufacturing method of a thin coupling inductor is characterized by comprising the following steps:
layout: a frame is arranged on the adhesive tape, a third magnetic core combination, a first winding main body and a second winding main body are arranged in the frame, a gap is between the third magnetic core combination and the first winding main body, and a gap is between the third magnetic core combination and the second winding main body;
Laminating: laminating a PP material in the frame, and removing the adhesive tape to form a first assembly;
And stacking: sequentially stacking a PP layer, a first magnetic core, another PP layer and a first copper layer in the top surface direction of the first assembly; sequentially stacking a PP layer, a second magnetic core, another PP layer and a second copper layer in the bottom surface direction of the first assembly, and forming a stack body after pressing; The first winding main body and the second winding main body are arranged in parallel; at least one part of the third magnetic core combination is arranged on the outer sides of the first winding main body and the second winding main body; winding ends are arranged at the two ends of the first winding main body and the two ends of the second winding main body, and the winding end parts are arranged in the stacking direction;
Preferably, the winding end part is arranged on the first assembly through welding, or the winding end part and the corresponding winding main body are integrally formed;
And the first magnetic core and the second magnetic core have a thin-layer composite structure; and the thin-layer composite structure comprises a plurality of magnetic material thin layers and an insulating layer arranged between the magnetic material thin layers, and the magnetic material thin layers comprises at least one of a nanocrystalline magnetic material, an amorphous strip magnetic material or a magnetic metal film.

Preferably, the manufacturing method, further comprising the following steps:
a through hole and a half hole are formed in the stack body, and the half hole is formed in the corresponding position of the winding end; the through hole is formed in the position of the avoiding winding main body;
And electroplating: electroplating the side walls of the half hole and the through hole to form a winding end and an electrical connector, wherein the electrical connector comprises a power connector and a signal connector.

Preferably, the manufacturing method, further comprising the following steps:
plastic packaging: performing plastic packaging on the surface of the stack body to form a plastic package body.
And arranging an electrical connector, wherein a power connector and a signal connector are arranged on the surface of the plastic packaging body;
The winding end is exposed on the surface of the plastic package body.

Preferably, in the step of layout, a first auxiliary winding main body and a second auxiliary winding main body are further arranged in the frame; the first auxiliary winding main body and the first winding main body are adjacent and are arranged in parallel, and gaps are set between them; the second auxiliary winding main body and the second winding main body are adjacent and are arranged in parallel, and gaps are set; auxiliary winding ends are arranged at the two ends of the first auxiliary winding main body and the two ends of the second auxiliary winding main body, and the winding end parts are arranged towards the bottom surface.

Preferably, in the layout, a plurality of third magnetic core combinations, a plurality of first winding main bodies and a plurality of second winding main bodies are arranged in the frame; and after the adhesive tape is removed, a plurality of first assemblies are formed through de-paneling.

Preferably, a plurality of first winding main bodies and a plurality of second winding main bodies corresponding to different first assemblies are a common whole during layout.

A power supply module comprises the thin coupling inductor. The power supply module further comprises a first switch unit, a second switch unit, an input capacitor and an output capacitor; and the first switch unit and the second switch unit are arranged on the top surface of the power supply module; the power supply module is provided with an input positive end, an output positive end and a grounding end, and the input positive end, the output positive end and the grounding end are arranged on the bottom surface of the power supply module; two winding ends corresponding to the first winding main body are electrically connected with the first switch unit and the output positive end respectively, and two winding ends corresponding to the second winding main body are electrically connected with the second switch unit and the output positive end respectively; control signals of the first switch unit and the second switch unit are staggered by 180 degrees; the input capacitor is bridged between the input positive end and the grounding end, and the output capacitor is bridged between the output positive end and the grounding end.

Preferably, wherein the thin coupling inductor is specifically a thin coupling inductor; the auxiliary winding end part faces the bottom surface of the power supply module; and the first auxiliary winding main body, the second auxiliary winding main body and the auxiliary winding end part are used for forming a trans-inductor voltage regulator (TLVR) closed loop by means of series electrical connection.

Compared with the prior art, the application has the following beneficial effects:
(1) The application provides a coupling inductance structure based on a nanocrystalline strip material and a corresponding process method. The coupling inductance of the thin type, the high saturation current, the high steady state inductance and the low dynamic inductance is obtained, so that the power density, the steady state performance and the dynamic performance of the power supply module are improved.

### BRIEF DESCRIPTION OF THE DRAWINGS

FIG. 1A and FIG. 1B are schematic diagrams of a step-down circuit.

FIG. 2A and FIG. 2B are schematic diagrams of nanocrystalline plates.

FIG. 3A to FIG. 3C are schematic diagrams of an inductor assembly 200a.

FIG. 4A to FIG. 4C are schematic diagrams of an inductor assembly 200b.

FIG. 5A and FIG. 5B are three-dimensional schematic diagrams of an inductor assembly 200c.

FIG. 5C and FIG. 5D are schematic diagrams of a combination body 260.

FIGS. 6A-6E are schematic diagrams of a first connector.

FIG. 6F and FIG. 6G are another schematic diagram of a combination body 260.

FIG. 6H is a schematic diagram of production of a connector.

FIG. 7A to FIG. 7C are three-dimensional schematic diagrams of an inductor assembly 200c.

FIGS. 8A to FIG. 8E are three-dimensional schematic diagrams of an inductor assembly 200d.

### DESCRIPTION OF THE EMBODIMENTS

The present application discloses various embodiments or examples of implementing the thematic technological schemes mentioned. To simplify the disclosure, specific instances of each element and arrangement are described below. However, these are merely examples and do not limit the scope of protection of this application. For instance, a first feature recorded subsequently in the specification formed above or on top of a second feature may include an embodiment where the first and second features are formed through direct contact, or it may include an embodiment where additional features are formed between the first and second features, allowing the first and second features not to be directly connected. Additionally, these disclosures may repeat reference numerals and/or letters in different examples. This repetition is for brevity and clarity and does not imply a relationship between the discussed embodiments and/or structures. Furthermore, when a first element is described as being connected or combined with a second element, this includes embodiments where the first and second elements are directly connected or combined with each other, as well as embodiments where one or more intervening elements are introduced to indirectly connect or combine the first and second elements.

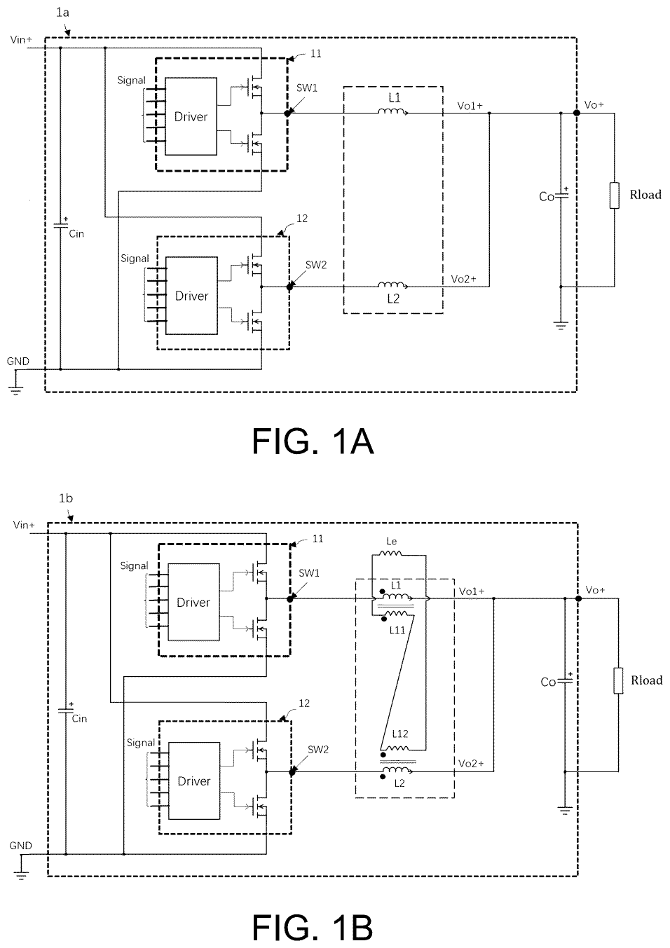

The step-down circuit 1a as shown in FIG. 1A is a conventional BUCK circuit having two phases connected in parallel, and the step-down circuit 1b as shown in FIG. 1B has a two-phase parallel BUCK circuit with a TLVR inductor. The step-down circuits 1a and 1b each comprise an input positive terminal Vin+, an output positive terminal Vo+, a grounding terminal GND, switch units 11 and 12, inductors L1 and L2, an input capacitor Cin and an output capacitor Co, the second end Vo1+ of the inductor L1 and the second end Vo2+ of the inductor L2 are electrically connected to the output positive end Vo+, the first end of the inductor L1 is electrically connected with the switch unit 11, the first end of the inductor L2 is electrically connected with the switch unit 12. The two ends of the half-bridge arm of the switch unit 11 and the switch unit 12 are bridged between the input positive end Vin+ and the grounding end GND of the step-down circuit, so that the input positive end Vin+ and the grounding end GND of the switch units 11 and 12 are formed; and the input capacitor Cin is bridged between the input positive end Vin+ and the grounding end GND. The output capacitor Co is bridged between the output positive terminal Vo+ and the ground terminal GND of the step-down circuit. The control signals of the switching units 11 and 12 are 180 degrees out of phase. The step-down circuit 1b further comprises auxiliary windings L11 and L12 and an external inductor Le, the auxiliary windings L11 and L12 and the external inductor Le are sequentially connected in series to form a closed loop (TLVR closed loop), and a TLVR technology is realized; the first end of the auxiliary winding L11 and the first end of the inductor L1 are dotted terminals and are marked as a first point end; the first end of the auxiliary winding L12 and the first end of the inductor L2 are dotted terminals and are labeled as second point ends; and the second end of the auxiliary winding L11 is electrically connected with the first end of the auxiliary winding L12.

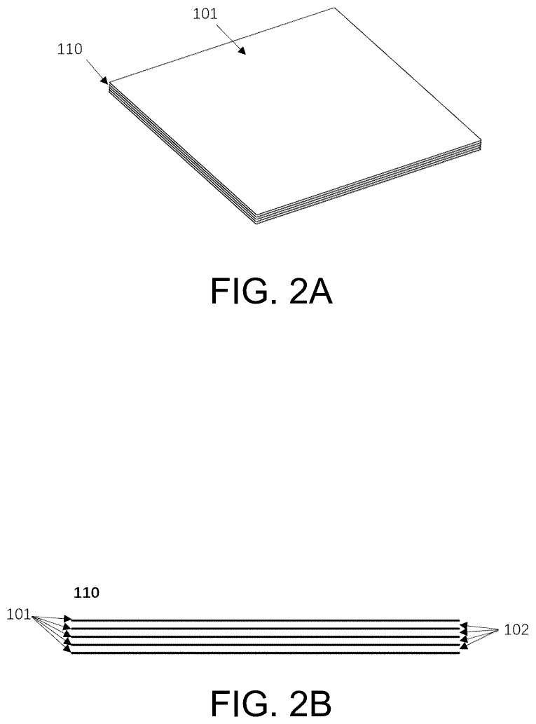

The nanocrystalline strip material is cut into the nanocrystalline sheet 101, the multiple nanocrystalline sheets 101 are overlapped together, and each nanocrystalline sheet 101 is bonded together through glue 102 to form the nanocrystalline sheet 110, as shown in FIG. 2A and FIG. 2B. In addition to the bonding function of the glue 102, because the resistivity of the nanocrystalline sheet 101 is low, the glue 102 can also realize reliable insulation between the sheet and the sheet, so that the eddy current loss of the nanocrystalline sheet 110 is reduced, and the purpose of reducing the loss density of the magnetic material is achieved. Since the glue 102 does not have magnetic conductivity, it is desirable that the thinner the glue between the nanocrystalline sheets 101. One of the solutions is to perform coating on the surface of the nanocrystalline sheet 101 by means of molecular lamination, so that an extremely thin insulating coating layer is formed on the surface of the nanocrystalline sheet 101; and then the plurality of nanocrystalline sheets 101 are bonded together by means of the glue 102. Only the nanocrystalline magnetic material is used as an example for description, but the following embodiments are not limited to nanocrystalline magnetic materials, and the same structure and process are also suitable for amorphous strip magnetic materials and metal thin film composite materials (Metal Flake Composite).

### Embodiment 1

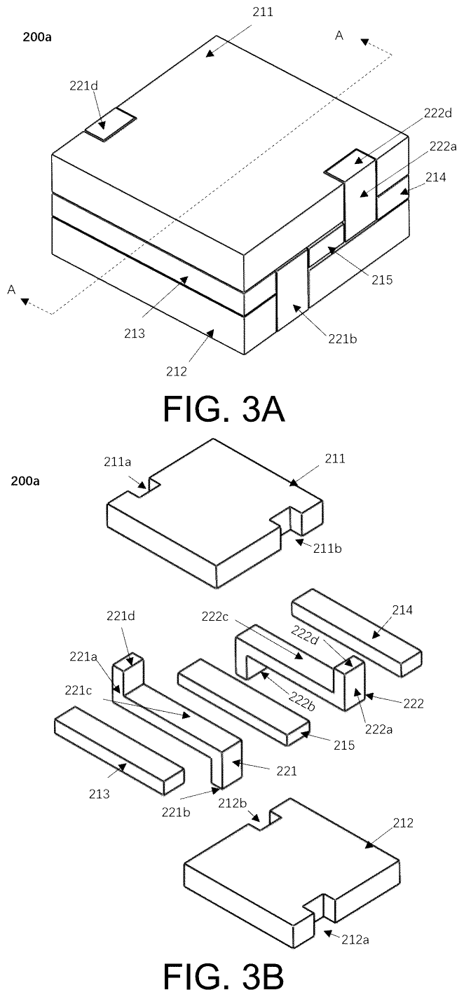

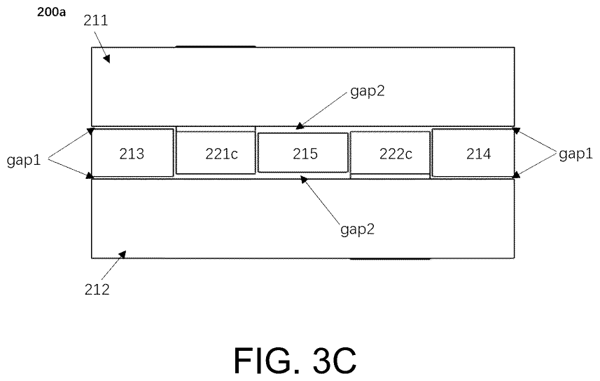

As shown in FIG. 3A, the inductors L1 and L2 in FIG. 1A of an inductor assembly 200a made of a nanocrystalline plate, and FIG. 3B is a perspective exploded view of the inductor assembly 200a. As shown in FIGS. 3A-3B, the inductor assembly 200a comprises a first magnetic core 211, a second magnetic core 212, a third magnetic core 213, a fourth magnetic core 214, a fifth magnetic core 215, a first winding 221, and a second winding 222, wherein the first magnetic core 211 is an upper magnetic cover of the inductor assembly; the second magnetic core 212 is a lower magnetic cover of the inductor assembly; the third magnetic core 213 and the fourth magnetic core 214 are side columns of the inductor assembly; and the fifth magnetic core 215 is a middle column of the inductor assembly. The magnetic cores 211 to 215 are all made of a nanocrystalline sheet 110, wherein the first magnetic core 211 and the second magnetic core 212 are formed by means of die stamping or by means of wire cutting to form slotted holes 211a, 211b, 212a and 212b, and the slotted holes 211a, 211b, 212a and 212b are used for setting a winding end or other power connectors similar to copper columns. In other embodiments, because the nanocrystalline plate 110 is high in hardness and high in stamping difficulty, the nanocrystalline sheet 101 can be stamped or wire cut out of a required slotted hole, and then the sheets with the slotted hole are bonded to the first magnetic core 211 and the second magnetic core 212 shown in FIG. 3B by means of the glue 102. In this way, the difficulty of stamping the plate is reduced, and the production cost is reduced.

In the embodiment, the third magnetic core 213, the first winding 221, the fifth magnetic core 215, the second winding 222 and the fourth magnetic core 214 are arranged in sequence. The first winding 221 comprises a first end 221a, a winding main body 221c and a second end 221b; the second winding 222 comprises the first end 221a, the winding main body 222c and the second end 221b. The first end 221a of the first winding 221 extends from the winding main body 221c to the first magnetic core 211, pass through the slot hole 211a, and form a SW1 pin 221d for connecting the switch unit 11 on the top surface of the inductor assembly 200a; the second end 221b extends from the winding main body 221c to the second magnetic core 212, passes through the slot hole 212a, and forms a Vo1+ pin on the bottom surface of the inductor assembly 200a; the first end 222a of the second winding 222 extends from the winding main body 222c to the first magnetic core 211, passes through the slot hole 211b, and forms a SW2 pin 222d for connecting the switch unit 12 on the top surface of the inductor assembly 200a; and the second end 222b extends from the winding main body 222c to the second magnetic core 212, passes through the slot hole 212b, and forms a Vo2+ pin on the bottom surface of the inductor assembly 200a. In the inductor assembly 200a shown in the embodiment, the third magnetic core 213, the fourth magnetic core 214, the fifth magnetic core 215, the first winding 221 and the second winding 222 can be independent and can also be integrally pressed, and then assembled together with the first magnetic core 211 and the second magnetic core 212. The third magnetic core 213, the fourth magnetic core 214, and the fifth magnetic core 215 are collectively referred to as a third magnetic core assembly 213a.

FIG. 3C is a cross-sectional view of the position A-A shown in FIG. 3A, and the third magnetic core 213, the first winding 221, the fifth magnetic core 215, the second winding 222 and the fourth magnetic core 214 are arranged in sequence. Air gaps are provided between the third magnetic core 213 and the first magnetic core 211 and between the third magnetic core 213 and the second magnetic core 212, and is defined as a first air gap, and the total height of the first air gaps is gap1. Air gaps are also arranged between the fourth magnetic core 214 and the first magnetic core 211 and between the fourth magnetic core 214 and the second magnetic core 212, and is also defined as a first air gap, and the total height of the first air gaps is gap1. Air gaps are also arranged between the fifth magnetic core 215 and the first magnetic core 211 and between the fifth magnetic core 215 and the second magnetic core 212, and is defined as a second air gap, and the total height of the second air gaps is gap2; and the gap1 is used for adjusting the coupling coefficient and the mutual inductance between the first winding and the second winding; and the gap2 is used for adjusting the leakage inductance between the first winding and the second winding.

When the inductor assembly 200a is applied to the two-phase BUCK circuit shown in

FIG. 1A, current flows into the SW1 pin 221d and the SW2 pin 222d, respectively, flows out of the Vo1+ pin and the Vo2+ pin, and the current directions flowing through the winding main bodies 221c and 222c are opposite, so that the inductor assembly 200a works in an anti-coupling state to form two anti-coupling inductors; and the magnetic flux generated by the current flowing through the first winding 221 and the magnetic flux generated by the current flowing through the second winding 222 are mutually reinforced in the fifth magnetic core 215. The inductor assembly 200a shown in the embodiment has high saturation current, low dynamic inductance and high steady-state inductance, and the requirement of high conversion efficiency is met while the dynamic performance of the step-down circuit 1a is improved. Meanwhile, due to the arrangement of the total height of the first air gap gap1 and the total height of the second air gap gap2, the steady-state inductance and the dynamic inductance can be flexibly adjusted to meet the requirements of different loads. Preferably, the total height of the first air gap gap1 is smaller than that of the total height of the second air gap gap2, and the total height of the first air gap gap1 is close to 0;

FIG. 3B is a structure of a magnetic core with a slot hole and an inductor assembly, and is also suitable for a conventional E-shaped magnetic core, a U-shaped magnetic core, etc., which is not limited herein.

In other embodiments, the first magnetic core 211 and the second magnetic core 212 can be arranged adopting nanocrystalline materials, and the third magnetic core 213, the fourth magnetic core 214 and the fifth magnetic core 215 are arranged adopting magnetic powder core materials. The nanocrystalline material has relatively high relative permeability, and the first magnetic core 211 and the second magnetic core 212 are arranged on the mutual magnetic flux path of the inductor assembly, so that the inductor assembly is high in coupling coefficient and good in coupling performance. and the magnetic powder core material has relatively high saturation magnetic flux density and relatively low equivalent magnetic conductivity; the total height gap2 between the fifth magnetic core 215 and the first magnetic core and between the fifth magnetic core 215 and the second magnetic core can be used for adjusting the leakage inductance; and meanwhile, the total height gap2 can be set to be close to 0, only the air gap caused by assembly exists, and the leakage inductance is adjusted only by adjusting the relative permeability of the fifth magnetic core 215. Similarly, the total height gap1 can be set to be close to 0, and only the air gap caused by assembly exists; in this way, the coupling coefficient and the mutual inductance can be completed by adjusting the relative permeability of the third magnetic core 213 and the fourth magnetic core 214. In the embodiment, by means of the method, the number of air gaps is reduced, and the inductor manufacturing process can be simplified; and the fifth magnetic core is arranged adopting magnetic powder core material with high saturation magnetic flux density, so that the saturation current of the inductor assembly can be improved.

Compared with the prior art (the first magnetic core 211 to the fifth magnetic core 215 both adopt a magnetic powder core material, or the magnetic cores 211-215 adopt ferrite materials). In the inductor assembly 200a of the embodiment, the first magnetic core 211 and the second magnetic core 212 adopt a nanocrystalline material by adopting, so that the equivalent steady-state inductance of the two anti-coupling inductors is increased, and the anti-saturation capacity of the two anti-coupling inductors under a large current condition is improved. Further, according to the embodiment of the application, the fifth magnetic core 215 is made of a magnetic powder core material, so that the anti-saturation capability of the two anti-coupling inductors under a large current condition is further improved. The fifth magnetic core 215 adopts a magnetic powder core material to improve the anti-saturation capability of the two anti-coupling inductors under a large current condition, and is not only suitable for occasions where the first magnetic core 211 and the second magnetic core 212 adopt nanocrystalline materials, but also suitable for occasions where the first magnetic core 211 and the second magnetic core 212 are made of ferrite materials.

### Embodiment 2

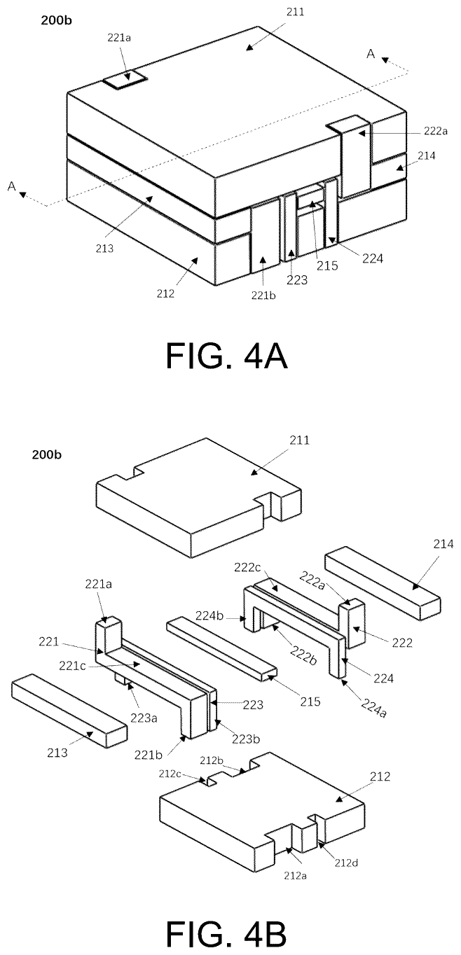

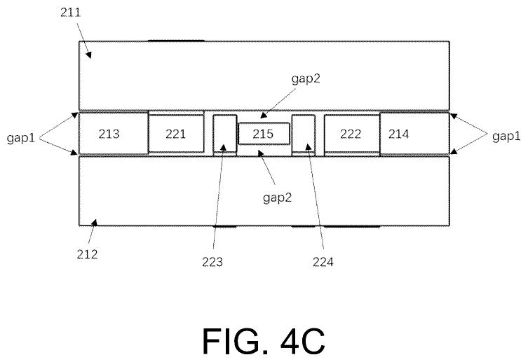

FIG. 4A is a three-dimensional structural diagram of the TLVR inductor shown in FIG. 1B, and FIG. 4B is a perspective exploded view of FIG. 4A. Compared with FIG. 3A, in the inductor assembly 200b shown in FIG. 4A, the first auxiliary winding 223 and the second auxiliary winding 224 are added between the first winding 221 and the fifth magnetic core 215, and are arranged adjacent to the first winding 221, and are magnetically coupled with the first winding 221; and a high-temperature-resistant insulating material (not shown) is arranged between the first auxiliary winding 223 and the first winding 221 and is used for realizing insulation between the first auxiliary winding 223 and the first winding 221. The second auxiliary winding 224 is disposed between the second winding 222 and the fifth magnetic core 215, and is disposed adjacent to the second winding 222, and is magnetically coupled with the second winding 222. An high-temperature-resistant insulating material is disposed between the second auxiliary winding 224 and the second winding 222. The first end 223a and the second end 223b of the first auxiliary winding 223 and the first end 224a and the second end 224b of the second auxiliary winding 224 both extend towards the bottom surface of the inductor assembly 200b. Correspondingly, the second magnetic core 212 is provided with a slot hole 212c and 212d. The slot hole 212a is used for the second end 221b of the first winding 221 and the second end 223b of the first auxiliary winding 223 to pass through; and the slot hole 212b is used for the second end 222b of the second winding 222 and the second end 224b of the second auxiliary winding 224; the slot hole 212c is used for the first end 223a of the first auxiliary winding 223 to pass through, and the slot hole 212d is used for the first end 224a of the second auxiliary winding 224 to pass through.

According to the inductor assembly 200b shown in the embodiment, with reference to the side cross-sectional view of the AA sectional line in FIG. 4A, as shown in FIG. 4C, the third magnetic core 213, the first winding 221, the first auxiliary winding 223, the fifth magnetic core 215, the second auxiliary winding 224, the second winding 222 and the fourth magnetic core 214 are sequentially arranged. The arrangement of the total height gap1 and the total height gap2 is the same as that of the inductor assembly 200a, and details are not described herein again. The first magnetic core to the fifth magnetic core are made of nanocrystalline materials, and the same technical effect in the inductor assembly 200a can also be obtained; in addition, the first magnetic core 211 and the second magnetic core 212 can also adopt a nanocrystalline material, the third magnetic core to the fifth magnetic core are made of magnetic powder core materials, the total height gap1 and the total height gap2 are set, the magnetic conductivity is set to be the same as that of the inductor assembly 200a, and the same technical features and benefits can also be obtained.

In the embodiment, the control signals in the two-phase parallel BUCK circuit are staggered by 180 degrees, and the structure of the inductor assembly is adopted, so that the inductor assembly in the power supply module can work in the anti-coupling state, small dynamic inductance and high steady-state inductance are achieved; the auxiliary winding is added on the basis of the anti-coupling inductor, and the TLVR technology is achieved, so that the dynamic inductance is further reduced, and the steady-state performance and the dynamic performance requirement of the power supply module are met.

### Embodiment 3

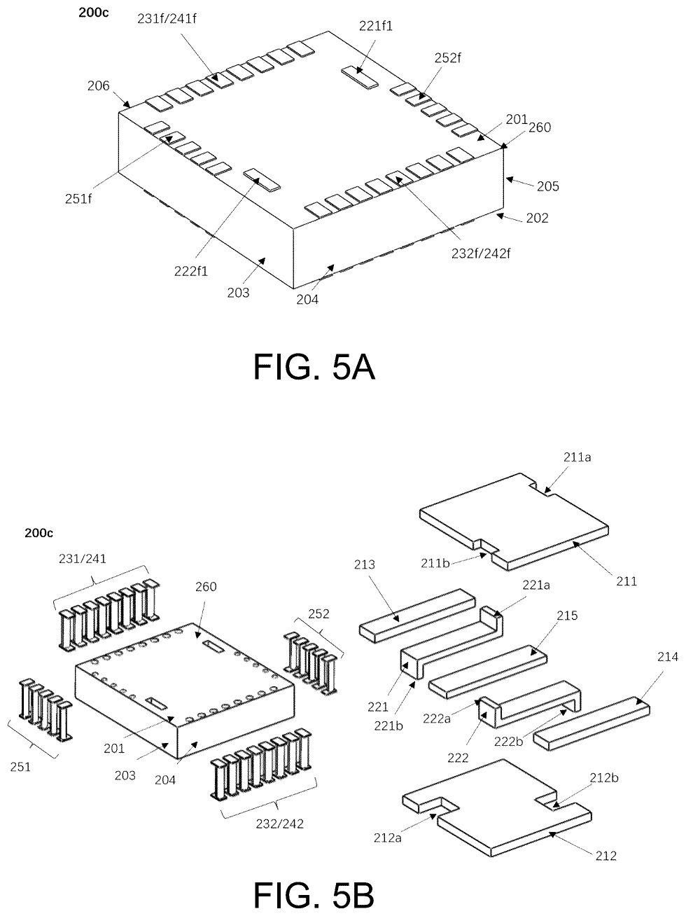

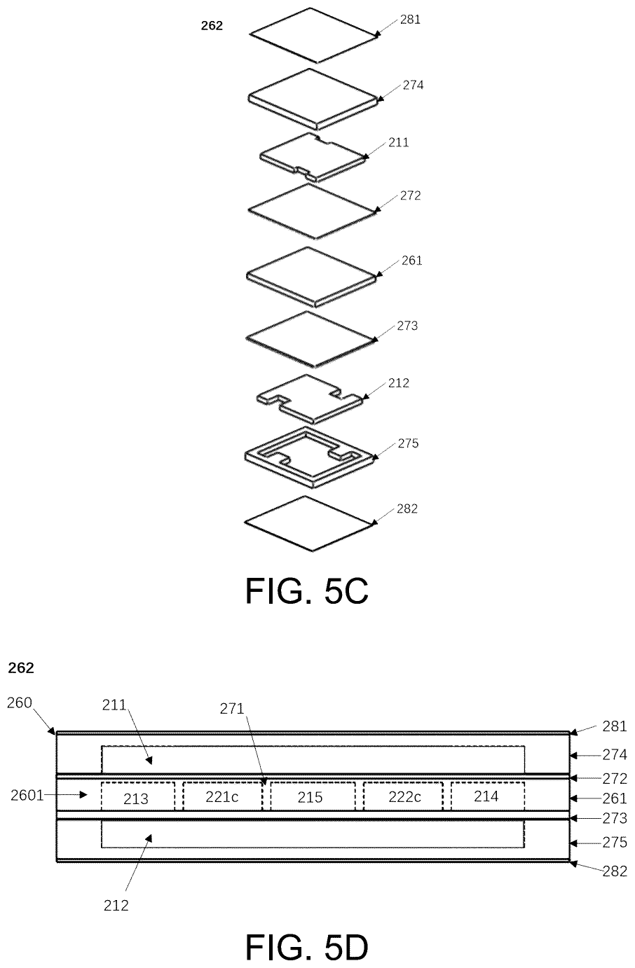

In order to further reduce the thickness of the inductor assembly, to meet the requirement of the power supply module on the thickness, and the application provides another inductor assembly structure and a manufacturing process. As shown in FIG. 5A, the three-dimensional structure diagram of the inductor assembly 200c is shown in FIG. 5A, and FIG. 5B is a schematic exploded view of the inductor assembly 200c. In the embodiment, the inductor assembly 200c comprises a first surface 201 and a second surface 202 which are opposite to each other, and further comprises a first side surface 203, a second side surface 204, a third side surface 205 and a fourth side surface 206 which are sequentially adjacent in the anticlockwise direction; the first surface 201 is the top surface of the inductor assembly 200c; and the second surface 202 is the bottom surface of the inductor assembly 200c. The inductor assembly 200c further comprises a first magnetic core 211, a second magnetic core 212, a third magnetic core 213, a fourth magnetic core 214, a fifth magnetic core 215, a first winding 221, a second winding 222, a first power connector 231/232, a second power connector 241/242, signal connectors 251 and 252 and the combination body 260. A pad 221f1 of the first winding 221, a pad 222f1 of the second winding 222, a pad 231f/232f of the first power connector 231/232, a pad 241f/242f of the second power connector 241/242, and a pad 251f/252f of the signal connector 251/252 are provided on the first surface 201 of the inductor assembly 200c; and correspondingly, a corresponding pad (not shown) is also provided on the second surface 202 of the inductor assembly 200c. In the inductor assembly 200c, the first magnetic core to the fifth magnetic core can be made of nanocrystalline materials, or amorphous strip magnetic materials or metal thin film composite materials (Metal Flame Composite) or the like, or some magnetic cores are made of magnetic powder core materials, so that the technical features and advantages disclosed by the application can be realized.

In the present embodiment, the first end 221a of the first winding 221 and the first end 222a of the second winding 222 respectively extend from the winding main bodies 221c and 222c to the first surface 201 of the inductor assembly 200c; the second end 221b of the first winding 221 and the second end 222b of the second winding 222 extend from the winding main bodies 221c and 222c to the second surface 202 of the inductor assembly 200c, respectively. The structures of the first winding 221 and the second winding 222 and the arrangement of the direction of the current flowing through the first winding 221 and the second winding 222 are the same as those in the previous embodiment. The first power connector 231 and the second power connector 241 are disposed adjacent to a fourth side surface 206 of the inductor assembly 200c, the first power connector 232 and the second power connector 242 are disposed adjacent to the second side surface 204, the signal connector 251 is disposed adjacent to the first side surface 203, and the signal connector 252 is disposed adjacent to the third side surface 205.

Further, as shown in FIG. 5C, the combination body 260 includes a first assembly 261, a second PP layer 272, a third PP layer 273, a fourth PP layer 274, a fifth PP layer 275, a first copper layer 281, and a second copper layer 282; and each layer in the combination body 260 is sequentially stacked according to the sequence of the first copper layer 281, the fourth PP layer 274, the second PP layer 272, the first assembly 261, the third PP layer 273, the fifth PP layer 275 and the second copper layer 282. Referring to the side profile shown in FIG. 5D, in the inductor assembly 200c, the first magnetic core 211 is arranged between the second PP layer 272 and the fourth PP layer 274; and the second magnetic core 212 is arranged between the third PP layer 273 and the fifth PP layer 275. The total height gap1 of the first air gap of the inductor assembly 200c and the total height gap2 of the second air gap can be set through the thicknesses of the second PP layer 272 and the third PP layer 273, and the size of the air gap can be adjusted by setting the thicknesses of the third magnetic core 213, the fourth magnetic core 214 and the fifth magnetic core 215, so that the purpose of adjusting the coupling performance between the first winding 221 and the second winding 222 is achieved. The first assembly 261 comprises a first PP layer 271, a third magnetic core 213, a fourth magnetic core 214, a fifth magnetic core 215, a first winding main body 221c and a second winding main body 222c, wherein the third magnetic core 213, the first winding main body 221c, the fifth magnetic core 215, the second winding main body 222c and the fourth magnetic core 214 are sequentially arranged in sequence.

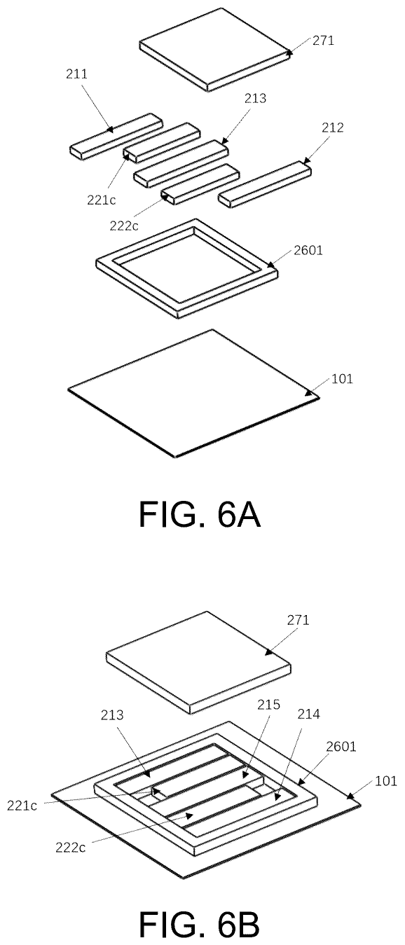

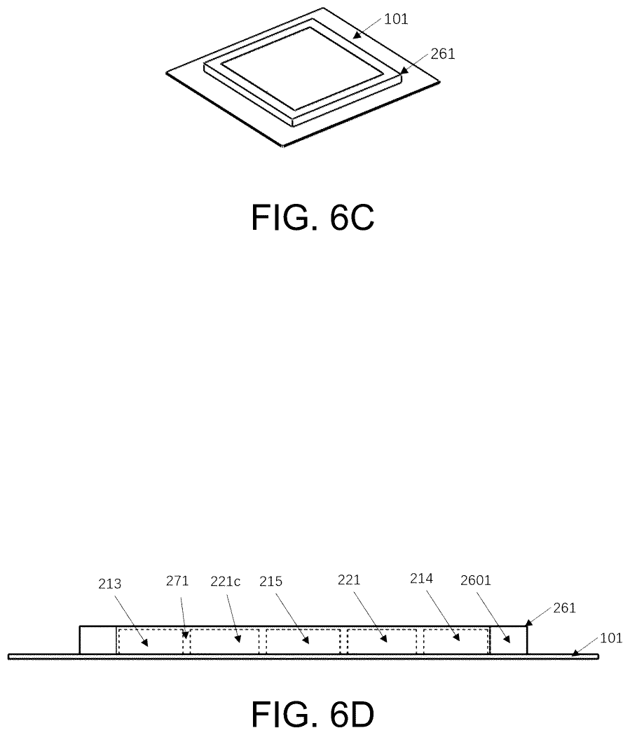

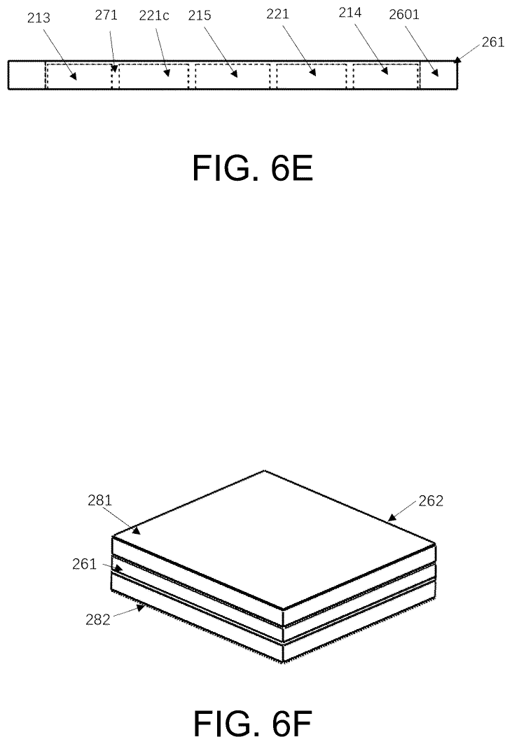

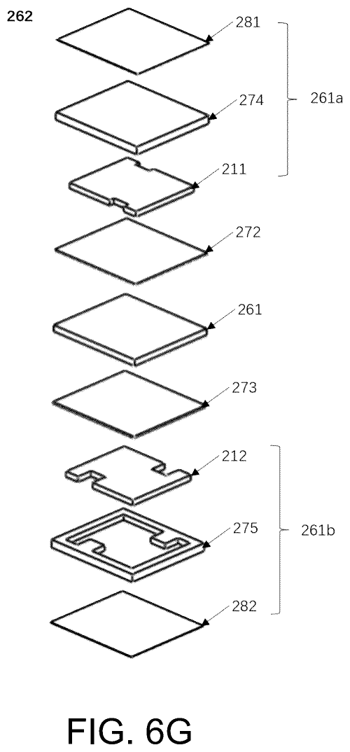

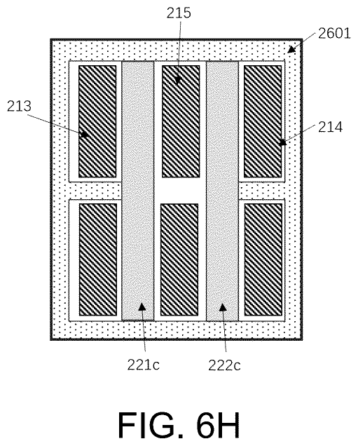

Referring to FIG. 6A to FIG. 6E, the manufacturing process of the first assembly 261 is as follows,
S1 layout: arranging a frame 2601 on the adhesive tape 101, and sequentially arranging a third magnetic core 213, a first winding main body 221c, a fifth magnetic core 215, a second winding main body 222c and a fourth magnetic core 214 in the frame 2601, wherein a gap is required between each winding main body and an adjacent magnetic core to ensure electrical isolation between the winding and the adjacent magnetic core. The frame 2601 may be a printed circuit board core board frame, but is not limited thereto.
S2 pressing: pressing a prepreg (PP for short) in the frame 2601, pressing the frame 2601, the third magnetic core 213, the first winding main body 221c, the fifth magnetic core 215, the second winding main body 222c and the fourth magnetic core 214 into a whole at one-time, and forming a first PP layer 271 in the frame 2601; and after the adhesive tape 101 is removed, the first assembly 261 can be obtained, the first PP layer 271 covers the third magnetic core 213, the first winding main body 221c, the fifth magnetic core 215, the second winding main body 222c and the fourth magnetic core 214; and the gap between the winding main body and the magnetic core is filled with the PP material, so that the insulation between the winding and the magnetic core can be realized.

Referring to FIG. 5C, respectively placing a second PP layer 272 and a third PP layer 273 on the top surface and the bottom surface of the first assembly 261; then placing a first magnetic core 211 on the top surface of the second PP layer 272, and placing a second magnetic core 212 on the bottom surface of the third PP layer 273; then, the fourth PP layer 274 and the fifth PP layer are disposed on the top surface and the bottom surface; finally, a first copper layer 281 is placed on the top surface of the fourth PP layer 274, and placing a second copper layer 282 on the bottom surface of the fifth PP layer 275; and laminating the layers to obtain the combination body 262 as shown in FIG. 6F, wherein the pressing process can be going on according to the process of the printed circuit board, but is not limited thereto, as long as the structure can be realized. In addition, referring to FIG. 6G, the pressing sequence of the combination body 262 can also be referred to as shown in FIG. 6G, the first copper layer 281, the first magnetic core 211, and the fourth PP layer 274 are pressed into the second assembly 261a; pressing the fifth PP layer 275, the second magnetic core 212 and the second copper layer 282 into a third assembly 261b; and then pressing the first assembly 261, the second assembly 261a and the third assembly 261b into the combination body 262 through the second PP layer 272 and the third PP layer 273b. The combination body 262 sequentially comprises a second assembly 261a, a first assembly 261 and a third assembly 261b from top to bottom.

In addition, the manufacture of the combination body 262 can also be realized in a manner of lamination on a PCB sheet panel and de-panel, as shown in FIG. 6H, and only two combination bodies 262 are taken as an example for description. The frame 2601 comprises two cavities, and a third magnetic core 213, a first winding main body 221c, a fifth magnetic core 215, a second winding main body 222c and a fourth magnetic core 214 are respectively arranged in each cavity from left to right; a common first winding main body 221c and a common second winding main body 222c are used in the two cavities, then de-panel and cut off the common first winding main body and the common second winding main body, so that two independent combination bodies 262 are formed in the two cavities. The two independent combination bodies 262 can also adopt independent first winding main bodies 221c and independent second winding main bodies 222c, and the two cavities are not limited thereto.

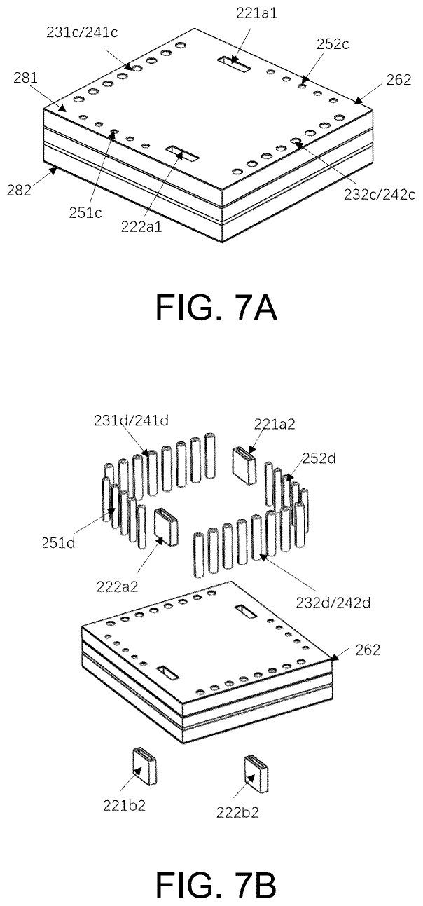

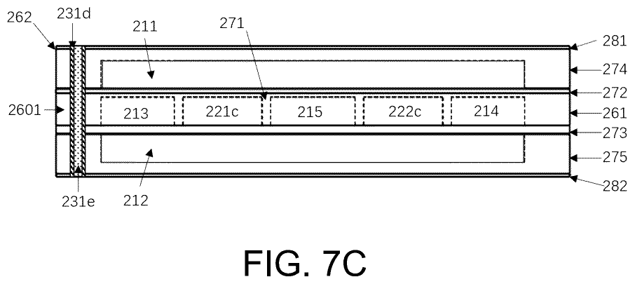

In the embodiment, the inductor assembly 200c further comprises through holes 231c/241c, 232c/242c, 251c/252c and blind holes 221a1/222a1, wherein the through holes 231c/241c, 232c/242c, 251c and 252c are arranged in the combination body 262 to be perpendicular to the frame 2601 so as to avoid the magnetic core part. The blind hole 221a1 is arranged at a position corresponding to the slot hole 211a of the first magnetic core 211 and is used for setting a first end 221a of the first winding 221; the blind hole 222a1 is arranged at a position corresponding to the slot hole 211b of the first magnetic core 211 and is used for setting a first end 222a of the second winding 222; and the openings of the blind holes 221a1 and 222a1 are exposed out of the first copper layer 281, and the depth is only to the position of the winding. The inductor assembly 200c further comprises blind holes 221b1 and 222b1 (not shown). The openings of the blind holes 221b1 and 222b1 are exposed out of the second copper layer 282, and the depth is only to the position of the winding; the blind holes 221b1 and 222b1 is used for setting the second ends 222b of the first winding 221 and the second ends 222b of the second winding 222. Copper deposition and electroplating are carried for the through holes 231c/241c, 232c/242c, 251c/252c and the blind holes 221a1, 222a1, 221b1 and 222b1; and referring to FIG. 7B, the blind hole plating layers 221a2, 222a2, 221b2 and 222b2 are long groove ring columns, one end of the long groove ring column is connected with the corresponding winding, and the other end of the long groove ring column extends to the top surface or the bottom surface of the inductor assembly 200c to form a first end or a second end corresponding to the winding; a first end surface corresponding to the winding is formed on the top surface of the inductor assembly 200c, and a second end surface corresponding to the winding is formed on the bottom surface of the inductor assembly 200c. The through hole plating layers 231d/241d, 232d/242d and 251d/252d are circular ring columns with a certain plating layer thickness; the cylindrical ring is exposed to the top surface and the bottom surface of the combination body 262 respectively, and the corresponding bonding pad on the first copper layer 281 and the corresponding bonding pad on the second copper layer 282 are electrically connected to form the power connector 231/232/241/242 and the signal connector 251/252; the through hole plating layers 231d/241d and 232d/242d are used for realizing connection and transmission of power between the bottom surface and the top surface of the combination body 262; and the through hole plating layer 251d/252d is used for realizing connection and transmission of signals between the bottom surface and the top surface of the combination body 262. In the embodiment, the through hole plating layers 231d/241d, 232d/242d and 251d/252d and the blind hole plating layers 221a2, 222a2, 221b2 and 222b2 are all or partially hollow, as shown in FIG. 7C, the through hole 231c is taken as an example for description. The through hole 231c is plated with copper deposition to form a plating layer 231d, and then the filling column 231e is formed by filling an insulating material (such as epoxy resin). In another embodiment, the through hole plating layers 231d/241d, 232d/242d and 251d/252d and the blind hole plating layers 221a2, 222a2, 221b2 and 222b2 are all conductive materials for enhancing the current capacity of the power connector and the first end and the second end of the winding, and improving the transmission efficiency of the inductor assembly. The bonding pads on the top surface and the bottom surface of the combination body 262 can form a first end surface and a second end surface of the winding by means of chemical etching to form a bonding pad of the power connector, and a bonding pad of the signal connector.

### Embodiment 4

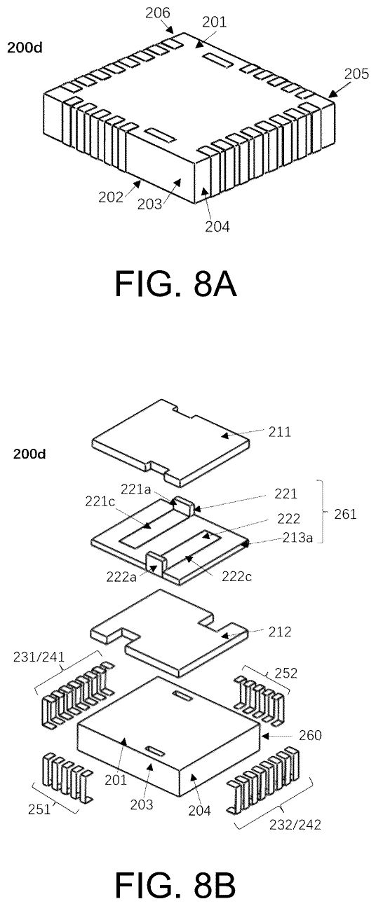

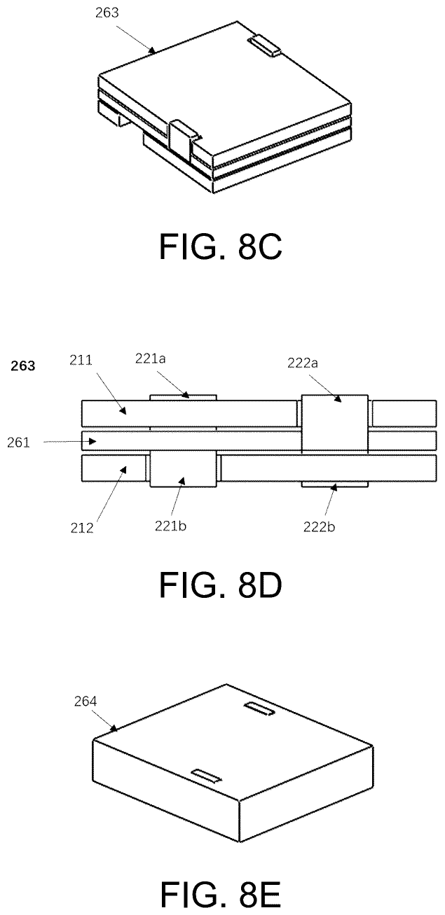

The application further provides an inductor assembly 200d, as shown in FIG. 8A, and the three-dimensional exploded view diagram of the inductor assembly 200d is shown in FIG. 8B. At the same time, referring to FIG. 8A and FIG. 8B, the inductor assembly 200d includes a first surface 201 and a second surface 202 opposite to each other, a first side surface 203, a second side surface 204, third side surface 205 and the fourth side surface 206 in the counterclockwise direction, the first surface 201 is a top surface of the inductor assembly 200d, and the second surface 202 is a bottom surface of the inductor assembly 200d. The inductor assembly 200d further comprises a first assembly 261, a first magnetic core 211, a second magnetic core 212, a first power connector 231/232, a second power connector 241/424, a signal connector 251/252 and a combination body 260. A first power connector 231, a second power connector 241 covering a part of the first surface 201, a partial side surface on the fourth side surface 206, and a part of the second surface 202; the first power connector 232 and the second power connector 242 wrap a part of the first surface 201, part of the second side surface 204 and the second surface 202; the signal connector 251 wraps part of the first surface 201, part of the first side surface 203 and part of the second surface 202, and the signal connector 252 wraps part of the first surface 201, part of the third side surface 205 and part of the second surface 202.

The inductor assembly 200d in Embodiment 4 disclosed in the present embodiment is substantially the same as the internal structure of the inductor assembly 200c in Embodiment 3, and also has the same technical effect as that in Embodiment 3; and the implementation process of the first assembly 261 and the winding end is different. The first assembly 261 in the inductor assembly 200d comprises a first winding 221, a second winding 222 and a third magnetic core assembly 213a, and the third magnetic core assembly 213a adopts a magnetic powder core material; and the first winding 221, the second winding 222 and the magnetic powder core material form the first assembly 261 through one-time pressing process. Magnetic powder core material has the characteristic of high resistivity, so that good insulation performance is achieved between the first winding 221 and the third magnetic core assembly 213a and between the second winding 222 and the third magnetic core assembly 213a, and the requirement can be met without additional insulation treatment. In the present embodiment, the third magnetic core assembly 213a has the same thickness as the first winding 221 and the second winding 222 (the end of the winding is not measured); the third magnetic core assembly 213a surrounds at least three side edges of the first winding 221, a first end 221a of the first winding 221 protrudes upwards and out of the third magnetic core assembly 213a, and a second end 221b of the first winding 221 protrudes downwards and out of the third magnetic core assembly 213a; the third magnetic core assembly 213a surrounds at least three side edges of the second winding 222, the first end 222a of the second winding 222 protrudes upwards and out of the third magnetic core assembly 213a, the second end 222b of the second winding 222 protrudes downward and out of the third magnetic core assembly 213a. The first assembly 261, the first magnetic core 211 and the second magnetic core 212 are assembled together to form a fourth assembly 263, FIG. 8C is a three-dimensional schematic diagram of the fourth assembly 263, and FIG. 8D is a side diagram of the fourth assembly 263. In other embodiments, the thickness of the third magnetic core assembly 213a between the two windings or the thickness of the outer side portion of the two windings can also be set to be lower than the thickness of the winding, so as to meet different inductor coupling requirements. Here, the part of the third magnetic core assembly 213a between the two windings can be considered as the middle column of the fourth assembly 263. When the thickness of the third magnetic core assembly 213a between the two windings is lower than the thickness of the winding, an air gap can be equivalent on the middle column. The first winding 221 and the second winding 222 can be integrally formed copper strips and are pressed with the magnetic material. In another embodiment, the first winding main body 221c, the second winding main body 222c and the magnetic material can also be pressed at one time, and then the first ends 221a and 222a and the second ends 221b and 222b are welded to the corresponding winding main bodies respectively to form the first winding 221 and the second winding 222.

Because the first magnetic core 211 and the second magnetic core 212 have electrical conductivity, insulation treatment needs to be performed between the first magnetic core 211 and the first winding 221 and the second winding 222; similarly, the second magnetic core 212 is insulated from the first winding 221 and the second winding 222. In the embodiment, the fourth assembly 263 is integrally plastic-packaged to form a fifth assembly 264, and as shown in FIG. 8E, an integrated inductor element can be formed, and insulation treatment between the winding and the magnetic core can be achieved. Metallization treatment is carried out on the surface of the fifth assembly 264, and the power connectors 231/241 and 232/242 and the signal connector 251/252 are electroplated, the inductor assembly 200d is obtained. According to the structure and the process method of the inductor assembly disclosed in the embodiment, the requirements of a thin inductor assembly and high power density are met, and the process is simplified.

The inductor assembly disclosed by the application can be applied to a power supply module with a vertical structure, and in combination with the circuit schematic diagram of the power supply module shown in FIG. 1A and FIG. 1B, the switch units 11 and 12 can be arranged on the top surface of the inductor assembly, and are electrically connected with a bonding pad of the winding or of a power connector and/or a signal connector on the top surface of the inductor assembly. The first power connector 231/232 is used for being electrically connected with the input positive end Vin+ of the bottom face of the power supply module and the input positive end Vin+ of the switch unit; the second power connector 241/242 is used for being electrically connected with the grounding end GND of the bottom surface of the power supply module and the grounding end GND of the switch unit. The power module is fixed and electrically connected with the pin adapter board or the system board through a pad on the bottom surface of the inductor assembly, and receives input power from the system board or provides power for a load on the system board, and realizes signal transmission between the switch unit and the system board through the signal connector.

The switch disclosed by the application can be a Si MOSFET, SiC MOSFET, GaN device or IGBT and etc, and the function of the switch disclosed by the application can be realized.

The power conversion device can be part of the electronic device or an independent power supply module as long as the technical features and advantages disclosed by the application can be satisfied.

The “equal” or “same” or “equal to” disclosed by the application needs to consider the parameter distribution of engineering, and the error distribution is within +/−30%; the two line segments or the two straight lines are defined as the two line segments or the included angle between the two line segments or the two straight lines is less than or equal to 45 degrees; the included angle between the two line segments or the two straight lines is within the range of [60, 120]; and the definition of the phase error phase also needs to consider the parameter distribution of the project, and the error distribution of the phase error degree is within +/−30%.

What is claimed is:

1. A thin coupling inductor, comprising: a first assembly, a first magnetic core and a second magnetic core,
wherein the first magnetic core, the first assembly and the second magnetic core are stacked, and the first assembly is arranged between the first magnetic core and the second magnetic core,
wherein the first assembly comprises a first winding main body, a second winding main body and a third magnetic core combination, wherein the third magnetic core combination, the first winding main body and the second winding main body are arranged in the same layer, wherein the first winding main body and the second winding main body are arranged in parallel, wherein at least one part of the third magnetic core combination is arranged on outer sides of the first winding main body and the second winding main body,
wherein winding ends are arranged at the two ends of the first winding main body and the two ends of the second winding main body, and winding end parts are arranged in a stacking direction,
wherein the first magnetic core and the second magnetic core have a thin-layer composite structure, and the thin-layer composite structure comprises a plurality of magnetic material thin layers and an insulating layer arranged between the magnetic material thin layers.

2. The thin coupling inductor according to claim 1, wherein the thin coupling inductor is provided with a first surface, a second surface, a first side surface, a second side surface, a third side surface and a fourth side surface, wherein the first surface is opposite to the second surface, the first side surface is opposite to the third side surface, and the second side surface is opposite to the fourth side surface,
wherein the thin coupling inductor further comprises a first copper layer, a second copper layer, an insulating layer, a power connecting piece and a signal connector,
wherein the first copper layer, the first magnetic core, the first assembly, the second magnetic core and the second copper layer are sequentially stacked from top to bottom, wherein the insulating layer is arranged between the first copper layer and the first magnetic core, between the first magnetic core and the first assembly, between the first assembly and the second magnetic core and between the second magnetic core and the second copper layer,
wherein a power connector is electrically connected to the first copper layer and the second copper layer, and the power connector is disposed adjacent to the second side surface and the fourth side surface, a signal connector is electrically connected to the first copper layer and the second copper layer, and the signal connector is disposed adjacent to the first side surface and the third side surface.

3. The thin coupling inductor of claim 2, wherein the winding end parts comprise a first end of the first winding, a second end of the first winding, a first end of the second winding and a second end of the second winding, wherein the first end of the first winding and the second end of the first winding are connected with the first winding main body, and the first end of the second winding and the second end of the second winding are connected with the second winding main body, wherein the first end of the first winding and the first end of the second winding respectively extend from the corresponding winding main body to the first copper layer and are electrically connected with the first copper layer, and the second end of the first winding and the second end of the second winding extend from the corresponding winding main body to the second copper layer and are electrically connected with the second copper layer.

4. The thin coupling inductor of claim 1, wherein the first magnetic core and the second magnetic core are provided with slotted holes respectively, and the winding ends are arranged in the slotted holes.

5. The thin coupling inductor of claim 4, wherein the winding end parts are an electroplated metal part, or the winding end parts are a welded metal part, or the winding end parts and the corresponding winding main body are integrally formed.

6. The thin coupling inductor of claim 1, wherein the third magnetic core combination is made of a magnetic powder core material.

7. The thin coupling inductor of claim 1, wherein the third magnetic core combination comprises a third magnetic core, a fourth magnetic core and a fifth magnetic core,
wherein the third magnetic core, the first winding main body, the fifth magnetic core, the second winding main body and the fourth magnetic core are sequentially arranged.

8. The thin coupling inductor of claim 7, wherein an air gap with a total height of a first gap is arranged between the third magnetic core and the first magnetic core, and between the third magnetic core and the second magnetic core, and wherein a total heights of the fourth magnetic core and the first magnetic core and between the fourth magnetic core and the second magnetic core is the first gap, and wherein an air gap with a total height of a second gap is arranged between the fifth magnetic core and the first magnetic core, and between the fifth magnetic core and the second magnetic core.

9. The thin coupling inductor of claim 8, wherein the total height of the first gap does not exceed the total height of the second gap.

10. The thin coupling inductor of claim 8, wherein the total height of the first gap is a sum of heights of assembly air gaps.

11. The thin coupling inductor of claim 1, wherein the first assembly further comprises a first auxiliary winding main body and a second auxiliary winding main body, wherein the first auxiliary winding main body and the first winding main body are arranged in parallel and are coupled, wherein the second auxiliary winding main body and the second winding main body are arranged in parallel and are coupled, wherein auxiliary winding ends are arranged at two ends of the first auxiliary winding main body and two ends of the second auxiliary winding main body, and end parts of the auxiliary winding are arranged in the stacking direction.

12. The thin coupling inductor of claim 11, wherein the first magnetic core and the second magnetic core are respectively provided with a slot hole, wherein the winding end parts are arranged in the slot hole, and the end parts of the auxiliary winding are arranged in the slot hole of the second magnetic core.

13. The thin coupling inductor of claim 1, wherein the first assembly further comprises a PP material area and an outer frame, wherein the first winding main body, the second winding main body and the third magnetic core are combined and arranged in the outer frame, and the PP material area is filled in a gap between the third magnetic core combination and the winding main body.

14. The thin coupling inductor of claim 1, wherein the plurality of magnetic material thin layers comprise at least one of a nanocrystalline magnetic material, an amorphous strip magnetic material, or a magnetic metal thin film.

15. The thin coupling inductor of claim 2, wherein the insulating layer is a PP layer, and the first copper layer, the first magnetic core, the first assembly, the second magnetic core, the second copper layer and the insulating layer are laminated to form a stack body.

16. The thin coupling inductor of claim 15 further comprising: a plastic package body, wherein the plastic package body wraps an outer surface of the stack body, and the power connector and the signal connector are arranged along a surface of the plastic package body, and the winding end parts are exposed out of the surface of the plastic package body.

17. The thin coupling inductor of claim 15, wherein a through hole penetrating from the first surface to the second surface is formed in the stack body, and the power connector and the signal connector are arranged in the through hole.

18. The thin coupling inductor of claim 1, wherein the thicknesses of the first winding main body, the second winding main body and the third magnetic core combination are same, the third magnetic core combination is a communication area, the third magnetic core combination is made of a magnetic powder core material, the third magnetic core combination surrounds at least three side edges of the first winding main body, and the third magnetic core combination surrounds at least three side edges of the second winding main body, and wherein the first winding main body, the second winding main body and the third magnetic core combination form a first assembly by pressing.

19. A manufacturing method of a thin coupling inductor, comprising:
forming a layout, comprising:
arranging a frame on the adhesive tape; and
arranging a third magnetic core combination, a first winding main body and a second winding main body in the frame, wherein a gap is reserved between the third magnetic core combination and the first winding main body, and a gap is reserved between the third magnetic core combination and the second winding main body;
laminating, comprising:
laminating a PP material in the frame; and
removing the adhesive tape to form a first assembly; and
stacking comprising:
sequentially stacking a PP layer, a first magnetic core, another PP layer and a first copper layer in a top surface direction of the first assembly;
sequentially stacking the PP layer, a second magnetic core, another PP layer and a second copper layer in a bottom surface direction of the first assembly; and
forming a stack body after pressing, wherein the first winding main body and the second winding main body are arranged in parallel, wherein at least one part of the third magnetic core combination is arranged on outer sides of the first winding main body and the second winding main body, wherein winding ends are arranged at two ends of the first winding main body and the two ends of the second winding main body, and winding end parts are arranged in a stacking direction.

20. The manufacturing method of claim 19, wherein the winding end parts are arranged on the first assembly through welding, or the winding end parts and the corresponding winding main body are integrally formed,
wherein the first magnetic core and the second magnetic core have a thin-layer composite structure, and the thin-layer composite structure comprises a plurality of magnetic material thin layers and an insulating layer arranged between magnetic material sheets, and the plurality of magnetic material thin layers are coated with at least one of a nanocrystalline magnetic material, an amorphous strip magnetic material or a magnetic metal film.

21. The manufacturing method of claim 19, further comprising:
forming a through hole and a half hole in the stack body, wherein the half hole is formed in the corresponding position of the winding end parts, wherein the through hole is formed in a position of an avoiding winding main body; and
electroplating side walls of the half hole and the through hole to form a winding end and an electrical connector, wherein the electrical connector comprises a power connector and a signal connector.

22. The manufacturing method of claim 19, further comprising:
performing plastic packaging on the surface of the stack body to form a plastic package body; and
arranging an electrical connector, wherein a power connector and a signal connector are arranged on the surface of the plastic packaging body,
wherein the winding end parts are exposed on a surface of the plastic package body.

23. The manufacturing method of claim 19, wherein in the step of layout, a first auxiliary winding main body and a second auxiliary winding main body are further arranged in the frame, wherein the first auxiliary winding main body and the first winding main body are adjacent and are arranged in parallel, and gaps are set between them, wherein the second auxiliary winding main body and the second winding main body are adjacent and are arranged in parallel, and gaps are set, wherein auxiliary winding ends are arranged at two ends of the first auxiliary winding main body and two ends of the second auxiliary winding main body, and the winding end parts are arranged towards a bottom surface.

24. The manufacturing method of claim 19, wherein in the layout, a plurality of third magnetic core combinations, a plurality of first winding main bodies and a plurality of second winding main bodies are arranged in the frame, wherein after the adhesive tape is removed, a plurality of first assemblies are formed through de-paneling.

25. The manufacturing method of claim 24, wherein a plurality of first winding main bodies and a plurality of second winding main bodies corresponding to different first assemblies are a common whole during the step of forming the layout.

26. A power supply module, comprising: a thin coupling inductor according to claim 1, wherein the power supply module further comprises a first switch unit, a second switch unit, an input capacitor and an output capacitor, wherein the first switch unit and the second switch unit are arranged on a top surface of the power supply module, wherein the power supply module is provided with an input positive end, an output positive end and a grounding end, and the input positive end, wherein the output positive end and the grounding end are arranged on a bottom surface of the power supply module, wherein two winding ends corresponding to the first winding main body are electrically connected with the first switch unit and the output positive end respectively, and two winding ends corresponding to the second winding main body are electrically connected with the second switch unit and the output positive end respectively, wherein control signals of the first switch unit and the second switch unit are staggered by 180 degrees wherein the input capacitor is bridged between the input positive end and the grounding end, and the output capacitor is bridged between the output positive end and the grounding end.

27. The power supply module of claim 26, wherein the first assembly further comprises a first auxiliary winding main body and a second auxiliary winding main body, wherein the first auxiliary winding main body and the first winding main body are arranged in parallel and are coupled, wherein the second auxiliary winding main body and the second winding main body are arranged in parallel and are coupled, wherein auxiliary winding ends are arranged at two ends of the first auxiliary winding main body and two ends of the second auxiliary winding main body, and end parts of the auxiliary winding are arranged in the stacking direction,
wherein a part of the auxiliary winding ends faces the bottom surface of the power supply module, and wherein the first auxiliary winding main body, the second auxiliary winding main body and the part of the auxiliary winding ends are used for forming a trans-inductor voltage regulator (TLVR) closed loop by means of series electrical connection.
